(19) United States
(12) Patent Application Publication
(10) Pub. No.: US 2026/0196501 A1
(43) Pub. Date: Jul. 9, 2026

(54) METHOD FOR PRODUCING A NEGATIVE ELECTRODE, NEGATIVE ELECTRODE, GALVANIC CELL, AND USES OF THE GALVANIC CELL

(71) Applicant: FRAUNHOFER-GESELLSCHAFT ZUR FÖRDERUNG DER ANGEWANDTEN FORSCHUNG E.V., München (DE)

(72) Inventors: Kathrin SCHAD, Stuttgart (DE); Kai Peter BIRKE, Stuttgart (DE); Max WEEBER, Stuttgart (DE)

(73) Assignee: FRAUNHOFER-GESELLSCHAFT ZUR FÖRDERUNG DER ANGEWANDTEN FORSCHUNG E.V., München (DE)

(21) Appl. No.: 19/108,922

(22) PCT Filed: Aug. 16, 2023
(86) PCT No.: PCT/EP2023/072604

§ 371 Date: Mar. 5, 2025

(30) Foreign Application Priority Data
Sep. 8, 2022 (DE) 10 2022 209 366.6

(51) Int. Cl. H01M 4/58; H01M 4/02; H01M 4/04; H01M 4/62; H01M 4/66; H01M 4/74; H01M 4/75

(52) U.S. Cl. CPC H01M 4/5825; H01M 4/0404; H01M 4/0435; H01M 4/623; H01M 4/667; H01M 4/669; H01M 4/742; H01M 4/75; H01M 2004/021; H01M 2004/027

(57) ABSTRACT

Disclosed is a method for producing a negative electrode, to a negative electrode, to a galvanic cell, and to uses of the galvanic cell. A coating which contains a polymer and/or ceramic particles is applied onto the upper face of a flat metal structure which does not consist of lithium, and a metal arrester is applied onto the lower face of the flat metal structure, said arrester having a plurality of openings in the direction of the metal structure. The metal arrester is then pressed into the metal structure by exerting a mechanical pressure, whereby the openings of the metal arrester are filled with metal of the metal structure at least in some regions. The method is simple and inexpensive to carry out and facilitates the production of a negative electrode which has many advantages.

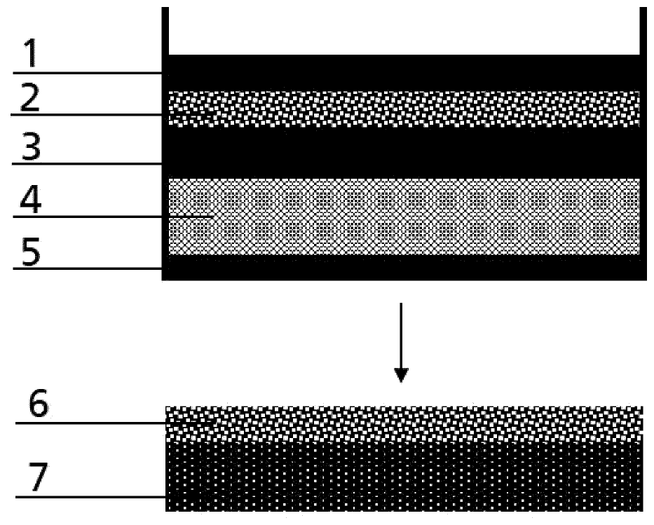

A method for producing a negative electrode, a negative electrode, a galvanic cell and uses of the galvanic cell are presented. In the method, a coating comprising or consisting of a polymer and/or ceramic particles is applied to an upper side of a planar metal structure which does not consist of lithium, and a metallic collector having a plurality of openings in the direction of the planar metal structure is applied to a lower side of the flat metal structure. The metallic collector is then pressed into the metal structure by exerting mechanical pressure, causing the openings of the metallic collector to fill with metal from the metal structure, at least in some regions. The method is simple and cost-effective and enables the production of a negative electrode that has a high energy density at cell level as well as high chemical, electrochemical and mechanical stability and thus has high cycle stability and enables high operating currents.

Commercial alkaline batteries (e.g., lithium-ion batteries with a graphite anode) have reached a limit in terms of possible energy density due to the materials used. In addition to the increasing performance requirements, high process-and delivery-related material costs are creating a need for alternative anode approaches.

To improve the energy density of alkaline batteries, it has been suggested in the literature to use metallic lithium, Li-metal alloys or Na-metal alloys (e.g., a LiAl alloy or a NaAl alloy) instead of a graphite-based negative electrode (anode). However, the use of pure lithium or metal alloys leads to insufficient cycle stability and is associated with high manufacturing costs and material costs.

CN 109244374 A discloses a method for producing a (negative) electrode for an alkaline battery. In the method, a nitrogen-doped stainless steel mesh and a metal foil consisting of lithium are mechanically pressed together in a tablet press to produce an electrode that has a three-dimensional, porous lithium metal composite material. The problem with using the metal foil, which consists of lithium, is that producing the electrode is cost-intensive due to the challenging handling of lithium metal and the high material costs. Furthermore, the cycle stability of this electrode could be improved.

JP S62 139276 A discloses a method for producing an alkaline battery in which a lithium-aluminum alloy is used in the negative electrode, wherein the lithium content in the lithium-aluminum alloy is adjusted to 35-45 mol %. The method involves the direct processing of lithium metal, i.e., lithium metal is alloyed with aluminum during the hot pressing process. Direct processing of lithium metal is challenging and cost-intensive. Furthermore, the cycle stability of the negative electrode of the manufactured alkaline battery is in need of improvement.

Based on this, it was the object of the present invention to provide a method for producing a negative electrode for a galvanic cell, a negative electrode for a galvanic cell and a galvanic cell which do not have the disadvantages of the prior art. In particular, the method should be simple and provide a negative electrode in a cost-effective manner which, when used in a galvanic cell, has a high energy density at cell level, a high chemical, electrochemical and mechanical stability and thus has a high cycle stability and enables high operating currents. Furthermore, uses of the galvanic cell should be proposed.

The problem is solved by the method with the features of claim 1, the negative electrode with the features of claim 8, the galvanic cell with the features of claim 15 and the use with the features of claim 16. The dependent claims describe advantageous developments.

According to the invention, a method for producing a negative electrode for a galvanic cell is provided, comprising
a) providing a planar metal structure selected from the group consisting of metal foil, expanded metal, perforated metal, metal mesh and combinations thereof, wherein the planar metal structure has a planar upper side and a planar lower side and has a certain height in a direction perpendicular to the upper side and lower side, wherein the metal structure is not made of lithium metal;
b) applying a coating to the upper side of the metal structure, the coating comprising or consisting of a polymer and/or ceramic particles;
c) applying a planar upper side of a planar metallic collector to the lower side of the metal structure, wherein the metallic collector has a planar lower side and has a certain height in a direction perpendicular to the upper side and lower side which is at most as great as the height of the metal structure, wherein the metallic collector has a plurality of openings at least on the upper side; and
d) pressing the metallic collector over a certain distance, which corresponds at least partially to the height of the metallic collector, into the metal structure by exerting mechanical pressure on the lower side of the metallic collector, whereby the openings of the metallic collector fill with metal of the metal structure at least along the certain distance.

The method according to the invention can be carried out in a simple and cost-effective manner. The method can be used to produce a negative electrode that has a high energy density at cell level, a high chemical, electrochemical and mechanical stability and thus has a high cycle stability and enables high operating currents.

These advantages result from pressing the metallic collector into the metal structure over a certain distance, which at least partially corresponds to the height of the metallic collector, while filling the openings of the metallic collector with metal from the metal structure, as this creates a very intimate mechanical contact and electrically conductive contact between the metal structure and the metallic collector on its lower side. If the electrically conductive contact and/or the metal structure has a metal oxide layer on the surface prior to pressing in (e.g., aluminum oxide in the case of aluminum), the pressing-in process causes the metal oxide layer to crack mechanically, which improves the electrical contact between the metal structure and the metallic collector. This also eliminates the voltage loss caused by the oxide layer breaking through during the first charge. The plurality of openings in the metallic collector, at least on the upper side, also means that material from the metal structure is pressed into these openings and a more homogeneous distribution of the current density can be achieved when the electrode is in operation.

During the pressing-in method carried out in accordance with the invention, a force is also inevitably exerted on the coating on the upper side of the metal structure, which presses the coating applied to the surface of the upper side of the metal structure onto the surface of the metal structure or even at least partially into it. As a result, there is also intimate mechanical contact between the metal structure and the coating on the upper side of the metal structure, which increases the mechanical load capacity and favors the electrolyte distribution at the interface due to the concentration gradient that is created. The homogeneous electrolyte distribution has the advantage of homogeneous alloy formation, which leads to increased cycle stability and optimized capacity utilization. During cell operation, a stable, immobilized, ion-conducting and electrically insulating passivation film consisting of decomposition products of the liquid electrolyte (solid electrolyte interface, SEI) forms in the pores of the coating. The coating takes on the role of an “SEI precursor”. The SEI stabilized by the coating serves as an additional protective layer for the metal structure. However, the coating may already comprise material that turns the coating into a solid electrolyte. In this case, solid electrolyte is present at the surface of the metal structure in concentrated form, i.e., the ionic conductivity at this interface is high. In this way, the polarization effects are minimized. The energy density of the electrode produced using the method is very high due to the feasibility of high-capacity anode materials such as the lithium-aluminum alloy.

The cycle stability of the electrode produced using the method is high, as the structure of the electrode produced suppresses dendrite growth. This also increases safety during operation of the manufactured electrode, as a dendrite-related short circuit can be avoided.

The production of the electrode using the method according to the invention is also simple and cost-effective, since no metal structure made of lithium metal is used.

The plurality of openings that the metallic collector has, at least on the upper side, can be continuous openings. Consequently, the metallic collector can also have a large number of openings on its lower side. The advantage here is that the homogeneity of the current density during operation of the electrode is further increased by the three-dimensionality of the collector structure. This results in a uniform material load and therefore increased cycle stability.

The metal structure used in the method may comprise or consist of aluminum, wherein the aluminum is optionally alloyed with a metal other than aluminum, preferably in a proportion of 0.1 to 20.0% by weight, particularly preferably 0.5 to 5.0% by weight, relative to the total weight of the metal structure. Such a metal structure has the advantage that its specific weight is very low (e.g., the specific density is only approx. 30% of that of copper) and its specific electrical conductivity is relatively high (e.g., the electrical conductivity is approx. 65% of that of copper). Consequently, aluminum has a better ratio of electrical conductivity to specific weight than copper, for example, which makes it more efficient and attractive than a metal structure made of copper, especially for mobile applications. Another advantage of aluminum is that it forms an alloy with lithium, which leads to a potential-related reduction in the risk of dendrites compared to lithium metal. Furthermore, aluminum can provide a low anode potential (U_anode) (U of LiAl alloy is about 0.3V vs Li/Li⁺, which is only slightly higher than the anode potential of commercially used graphite). In addition, aluminum can provide a high specific capacity (e.g., as LiAl 993 Ah/kg, which corresponds to three times the capacity of graphite). Due to the high resulting total capacity C and the high resulting cell voltage U (U=U_cathode-U_anode), aluminum enables a high energy density E=C*U at cell level and is more cost-effective than other suitable alloy formers such as indium or silicon.

Furthermore, the metal structure used in the method may comprise at least one element selected from the second main group of the periodic table, the third main group of the periodic table, fourth main group of the periodic table, a subgroup of the periodic table and combinations thereof, wherein the at least one element is preferably selected from the group consisting of magnesium, indium, zinc, tin, silicon, manganese and combinations thereof.

Furthermore, the metal structure used in the method may have a height, in a direction perpendicular to a surface of the metal structure, in the range of 1 to 100 μm, preferably 5 to 50 μm, particularly preferably 10 to 40 μm.

Moreover, the metal structure used in the process may have an upper side and/or lower side that has a surface texturing. The surface texturing can be selected from the group consisting of brushed surface texturing, ribbed surface texturing, embossed surface texturing and combinations thereof.

The ceramic particles of the coating used in the method may comprise or consist of a material selected from the group consisting of ceramic oxide, ceramic sulfide, ceramic sulfate, ceramic phosphide, ceramic phosphate, ceramic silicate, ceramic nitride, ceramic nitrate, and combinations thereof. The material used in the method is particularly preferably selected from the group consisting of lithium phosphorus sulfide (Li₃PS₄), lithium germanium phosphorus sulfide (Li₁₀GeP₂S₁₂), lithium silicon phosphorus sulfide (Li₁₁Si₂PS₁₂), Li₆PS₅Cl, Li₆PS₅Br, aluminum oxide, aluminum silicate, lithium aluminum silicate and combinations thereof, wherein the material is particularly aluminum oxide (Al₂O₃). Al₂O₃ has the advantage of being cost-effective compared to solid electrolyte salts such as lithium phosphorus sulfide. Furthermore, Al₂O₃ forms an inert protective layer so that no undesirable side reactions occur. In addition, the processing of Al₂O₃ particles in the coating creates porous structures, which results in an optimized electrolyte distribution, i.e., an SEI precursor effect.

Furthermore, the material used in the method may have an average particle diameter d₅₀ in the range from 0.05 to 30 μm, preferably in the range from 0.1 to 1 μm, where the average particle diameter refers to a particle diameter determined by dynamic light scattering.

The polymer of the coating used in the method may comprise or consist of a plastic selected from the group consisting of acrylonitrile-butadiene rubber, hydrogenated acrylonitrile-butadiene rubber, polyisobutylene and combinations thereof. The plastics selected from this group have the advantage that the coating binds to the (top side of the) metal structure with a high binding force (i.e., they are polymeric binders). The binding force is higher than that of polyolefins (e.g., polypropylene). If the coating also comprises ceramic particles, the binding force to the ceramic particles is also high, making them stable in the coating. The plastic is preferably polyisobutylene. Polyisobutylene has the advantage that it provides good adhesion, i.e., good adhesion of the coating, and the sustainability and environmental compatibility of polyisobutylene is higher compared to fluorinated compounds.

Furthermore, the polymer used in the method may comprise or consist of a fluorinated plastic, wherein the fluorinated plastic is in particular selected from the group consisting of PVDF, PVDF-HFP and combinations thereof. The plastics selected from this group also have the advantage that the coating binds to the (upper side of the) metal structure with a high binding force (i.e., they are polymeric binders). The binding force is higher than that of polyolefins (e.g., polypropylene). If the coating also comprises ceramic particles, the binding force to the ceramic particles is also high, making them stable in the coating.

In this method, the coating can be mechanically rolled on.

Furthermore, the coating can be applied in the process via wet coating and/or dry coating. Furthermore, in the method, the coating can be pressed onto, and preferably into, the metal structure by exerting a mechanical pressure on the coating in the direction of the metal structure of at least 2000 kg/cm², preferably a mechanical pressure in the range of 2500 to 6000 kg/cm². It is particularly preferable to apply the mechanical pressure via a cold lever press for a period of 10 to 20 seconds at a temperature in the range of 20 to 30° C.

In addition, the coating applied in the method can have a height in the range from 0.05 to 200 μm, preferably 0.1 to 100 μm, in a direction perpendicular to the upper side of the metal structure.

Furthermore, the coating applied in the method can be a porous coating.

In addition, the coating applied in the method can be contacted with a liquid electrolyte and/or gel electrolyte for a galvanic cell.

The liquid electrolyte and/or gel electrolyte may comprise a liquid selected from the group consisting of EC, PC, DMC, EMC, DEC, VEC, VC, FEC, TBAC (acetyltributyl citrate), GTB (glycerol tributyrate), GTA (glycerol triacetate), y-buthyrolactone, ionic liquid, and combinations thereof. and combinations thereof, particularly preferably a liquid selected from the group consisting of PC, FEC, EC, VEC, TBAC, GTB, GTA, ionic liquid and combinations thereof. PC, FEC, EC, VEC, TBAC, GTB, GTA and ionic liquids have the advantage that they are high-boiling liquids with high temperature stability, which reduces the risk of fire and increases operational safety.

Furthermore, the liquid electrolyte and/or gel electrolyte may comprise a lithium conducting salt and/or a sodium conducting salt, wherein the lithium conducting salt is in particular selected from the group consisting of LiPF₆, LiClO₄, LiNO₃, C₆H₁₈LiNSi₂, F₂LiNO₄S₂, C₂F₆LiNO₄S₂, LiB[C₂O₄]₂, LiBF₄ and combinations thereof and/or the sodium conducting salt is in particular selected from the group consisting of NaPF₆, NaBF₄, NaTF, NaTFSI, NaClO₄ and combinations thereof.

In addition, the coating applied in the process can assume a quasi-solid state or a gel-like state through contact with a liquid electrolyte.

The metallic collector used in the method may comprise or consist of a metal that has a higher Vickers hardness than the metal of the metal structure.

Further, the metallic collector used in the method may comprise or consist of a metal selected from the group consisting of stainless steel, copper, nickel and combinations and alloys thereof, wherein the metal is preferably stainless steel, in particular stainless steel 1.4301. Stainless steel has the advantage that it has a high Vickers hardness and does not form an alloy with lithium. It is also available as a cost-effective commercial material in all shapes and structures.

Furthermore, the metallic collector used in the method can be pressed into the metal structure by applying a mechanical pressure to the lower side of the metallic collector in the direction of the metal structure of at least 2000 kg/cm², preferably a mechanical pressure in the range from 2500 to 6000 kg/cm², the mechanical pressure being applied particularly preferably via a cold lever press for a duration of 10 to 20 seconds at a temperature in the range from 20 to 30° C.

Moreover, the metallic collector used in the method can have a large number of continuous openings from the upper side to the lower side.

In addition, the metallic collector used in the process may contribute to mechanical resistance to volumetric expansion during cycling when the electrode is operated in a galvanic cell, and in particular may be mechanically resistant to volumetric expansion during cycling when the electrode is operated in a galvanic cell.

Furthermore, the metallic collector used in the method can have a height in the range from 1 to 100 μm, preferably 5 to 50 μm, particularly preferably 10 to 40 μm, optionally 10 to 20 μm, in a direction perpendicular to the lower side of the metal structure.

The metallic collector used in the method can be designed as a perforated foil, perforated expanded metal or wire mesh. The metallic collector is preferably designed as a wire mesh. The advantage of a wire mesh is that finely distributed heterogeneities can be introduced through a fine-meshed mesh, resulting in a homogeneous, three-dimensional current density distribution over the entire negative electrode (anode). The wire mesh preferably has a mesh size in the range from 0.01 to 0.1 mm, in particular in the range from 0.04 to 0.063 μm. Furthermore, it is particularly preferred that the wire mesh comprises or consists of wires which have a diameter in the range from 0.020 to 0.050 mm, preferably in the range from 0.028 to 0.040 mm.

According to the invention, there is further provided a negative electrode for a galvanic cell, comprising or consisting of
i) a planar metal structure selected from the group consisting of metal foil, expanded metal, perforated metal, metal mesh and combinations thereof, wherein the metal structure has a planar upper side and a planar lower side and has a certain height in a direction perpendicular to the upper side and lower side, wherein the metal structure is not made of lithium metal;
ii) a coating applied to the upper side of the metal structure, the coating comprising or consisting of a polymer and/or ceramic particles; and
iii) a planar metallic collector, wherein the metallic collector has a planar upper side and planar lower side and has a certain height in a direction perpendicular to the upper side and lower side which is at most as great as the height of the metal structure, wherein the metallic collector has a plurality of openings at least on the upper side;
   wherein the metallic collector is embedded in the metal structure over a certain distance from the lower side of the metal structure towards the upper side of the metal structure, wherein the certain distance corresponds at least partially to the height of the metallic collector and wherein openings of the metallic collector are filled with metal of the metal structure at least along the certain distance.

The negative electrode according to the invention is easy and inexpensive to provide. It has a high energy density at cell level as well as high chemical, electrochemical and mechanical stability and thus exhibits high cycle stability. It also enables high operating currents.

The metal structure of the electrode may comprise or consist of aluminum, the aluminum optionally being alloyed with a metal other than aluminum, preferably in a proportion of 0.1 to 20.0% by weight, particularly preferably 0.5 to 5.0% by weight, relative to the total weight of the metal structure. Such a metal structure has the advantage that its specific weight is very low (e.g., the specific density is only approx. 30% of that of copper) and its specific electrical conductivity is relatively high (e.g., the electrical conductivity is approx. 65% of that of copper). Consequently, aluminum has a better ratio of electrical conductivity to specific weight than copper, for example, which makes it more efficient and attractive than a metal structure made of copper, especially for mobile applications. Another advantage of aluminum is that it forms an alloy with lithium, which contributes to a potential-related reduction in the risk of dendrites compared to lithium metal. Furthermore, aluminum can provide a low anode potential U (U of LiAl alloy is about 0.3V vs Li/Li⁺, which is comparable to graphite). Furthermore, aluminum can provide a high specific capacity (e.g., as LiAl 993 Ah/kg, which corresponds to three times the capacity of graphite). In addition, aluminum enables a high energy density E=C*U and is more cost-effective than other suitable alloy formers such as indium or silicon.

Furthermore, the metal structure of the electrode can comprise at least one element selected from the second main group of the periodic table, the third group of the periodic table, the fourth group of the periodic table, a subgroup of the periodic table and combinations thereof, wherein the at least one element is preferably selected from the group consisting of magnesium, indium, zinc, tin, silicon, manganese and combinations thereof.

Apart from this, the metal structure of the electrode can have a height, in a direction perpendicular to the upper side of the metal structure, in the range from 1 to 100 μm, preferably 5 to 50 μm, particularly preferably 10 to 40 μm.

In addition, the metal structure of the electrode can have an upper side and/or lower side with a surface texturing. The surface texturing can be selected from the group consisting of brushed surface texturing, ribbed surface texturing, embossed surface texturing and combinations thereof.

The ceramic particles of the coating may comprise or consist of a material selected from the group consisting of ceramic oxide, ceramic sulfide, ceramic sulfate, ceramic phosphide, ceramic phosphate, ceramic silicate, ceramic nitride, ceramic nitrate, and combinations thereof. Particularly preferably, the material is selected from the group consisting of lithium phosphorus sulfide (Li₃PS₄), lithium germanium phosphorus sulfide (Li₁₀GeP₂S₁₂), lithium silicon phosphorus sulfide (Li₁₁Si₂PS₁₂), Li₆PS₅Cl, Li₆PS₅Br, aluminum oxide, aluminum silicate, lithium aluminum silicate and combinations thereof, wherein the material is in particular aluminum oxide (Al₂O₃). Al₂O₃ has the advantage of being cost-effective compared to solid electrolyte salts such as lithium phosphorus sulfide. Furthermore, Al₂O₃ forms an inert protective layer so that no undesirable side reactions occur. In addition, the processing of Al₂O₃ particles in the coating ensures a porous structure, which results in an optimized electrolyte distribution, i.e., an SEI precursor effect.

Furthermore, the ceramic particles of the coating can have an average particle diameter d₅₀ in the range from 0.05 to 30 μm, preferably in the range from 0.1 to 1 μm, whereby the average particle diameter refers to a particle diameter determined by dynamic light scattering.

The polymer of the coating may comprise or consist of a plastic selected from the group consisting of acrylonitrile-butadiene rubber, hydrogenated acrylonitrile-butadiene rubber, polyisobutylene and combinations thereof. The plastic is preferably polyisobutylene.

Polyisobutylene has the advantage that it causes good adhesion, i.e., good adhesion of the coating. Furthermore, the sustainability and environmental compatibility of polyisobutylene is higher compared to fluorinated compounds.

Furthermore, the polymer of the coating may comprise or consist of a fluorinated plastic, wherein the fluorinated plastic is in particular selected from the group consisting of PVDF, PVDF-HFP and combinations thereof.

The coating can be mechanically rolled on.

Furthermore, the coating can be applied via wet coating and/or dry coating.

Furthermore, the coating may have been pressed onto, and preferably into, the metal structure by applying a mechanical pressure to the coating in the direction of the metal structure of at least 2000 kg/cm², preferably a mechanical pressure in the range of 2500 to 6000 kg/cm², the mechanical pressure having been applied particularly preferably via a cold lever press for a duration of 10 to 20 seconds at a temperature in the range of 20 to 30° C.

Moreover, the coating can have a height in the range of 0.05 to 2 μm, preferably 0.1 to 1 μm, in a direction perpendicular to the upper side of the metal structure.

The coating can be a porous coating.

Furthermore, the coating can have a liquid electrolyte and/or gel electrolyte for a galvanic cell.

The liquid electrolyte and/or gel electrolyte may comprise a liquid selected from the group consisting of EC, PC, DMC, EMC, DEC, VEC, VC, FEC, TBAC (acetyltributyl citrate), GTB (glycerol tributyrate), GTA (glycerol triacetate), y-buthyrolactone, ionic liquid and combinations thereof. Particularly preferably, the liquid electrolyte and/or gel electrolyte comprises a liquid selected from the group consisting of PC, FEC, EC, VEC, TBAC, GTB, GTA, ionic liquid and combinations thereof. PC, FEC, EC, VEC, TBAC, GTB, GTA and ionic liquids have the advantage that they are high-boiling liquids with high temperature stability, which reduces the risk of fire and increases operational safety.

Furthermore, the liquid electrolyte and/or gel electrolyte may comprise a lithium conducting salt and/or a sodium conducting salt, wherein the lithium conducting salt is in particular selected from the group consisting of LiPF₆, LiClO₄, LiNO₃, C₆H₁₈LiNSi₂, F₂LiNO₄S₂, C₂F₆LiNO₄S₂, LiB[C₂O₄]₂, LiBF₄ and combinations thereof and/or the sodium conducting salt is in particular selected from the group consisting of NaPF₆, NaBF₄, NaTF, NaTFSI, NaClO₄ and combinations thereof.

In addition, the liquid electrolyte and/or gel electrolyte (due to the presence of a liquid electrolyte) can be present in a quasi-solid state or a gel-like state.

The metallic collector can comprise or consist of a metal that has a higher Vickers hardness than the metal of the metal structure.

Furthermore, the metallic collector may comprise or consist of a metal selected from the group consisting of stainless steel, copper, nickel and combinations and alloys thereof, wherein the metal is preferably stainless steel, in particular stainless steel 1.4301. Stainless steel has the advantage that it has a high Vickers hardness and does not form an alloy with lithium. It is also available as a cost-effective commercial material in all shapes and structures.

In addition, the metallic collector may have been pressed into the metal structure by applying a mechanical pressure to the lower side of the metallic collector in the direction of the metal structure of at least 2000 kg/cm², preferably a mechanical pressure in the range of 2500 to 6000 kg/cm², the mechanical pressure was particularly preferably applied via a cold lever press for a duration of 10 to 20 seconds at a temperature in the range of 20 to 30° C.

Moreover, the metallic collector can have a large number of continuous openings from the top to the bottom.

It is preferred that the metallic collector contributes to the mechanical resistance to volumetric expansion during cycling when the electrode is operated in a galvanic cell, in particular that it is mechanically resistant to volumetric expansion during cycling when the electrode is operated in a galvanic cell.

In a direction perpendicular to the lower side of the metal structure, the metallic collector can have a height in the range of 1 to 100 μm, preferably 5 to 50 μm, particularly preferably 10 to 40 μm, optionally 10 to 20 μm.

The metallic collector can be designed as a perforated foil, perforated expanded metal or wire mesh. The metallic collector is preferably designed as a wire mesh. The advantage of a wire mesh is that finely distributed heterogeneities can be introduced through a fine-meshed mesh, resulting in a homogeneous, three-dimensional current density distribution over the entire negative electrode (anode). The wire mesh preferably has a mesh size in the range from 0.01 to 0.1 mm, in particular in the range from 0.04 to 0.063 μm. Furthermore, the wire mesh particularly preferably comprises or consists of wires which have a diameter in the range from 0.020 to 0.050 mm, preferably in the range from 0.028 to 0.040 mm.

In a preferred embodiment, the negative electrode according to the invention is manufactured using the method according to the invention. In this case, the negative electrode according to the invention has features that are inevitably caused by carrying out the method according to the invention in the negative electrode.

According to the invention, a galvanic cell is also provided which comprises a negative electrode (anode) according to the invention, a cathode and an electrolyte. The electrolyte is preferably a liquid electrolyte which, due to diffusion into the coating, can be present in a gel formed by the coating and the liquid electrolyte.

It is further proposed to use the galvanic cell according to the invention to supply power to i) a mobile device, preferably a cell phone, a vehicle, an airplane and/or a ship; and/or ii) a stationary device, preferably a building.

With reference to the following figure and the following example, the object according to the invention will be explained in more detail, without wishing to limit it to the specific embodiments shown here.

The figure schematically shows the method according to the invention and an electrode according to the invention. A coating 2 (e.g., aluminum silicate coating) is applied to the upper side of a metal structure 3 (e.g., an aluminum foil) and a metallic collector 4 (e.g., a stainless steel wire mesh) is applied to the lower side. This metal structure is arranged between an upper press plunger 1 of a cold lever press and a lower press plunger 5 of a cold lever press and a pressing force is exerted by the cold lever press on the coating 2 of the metal structure 3 in the direction of the metal structure 3 on the one hand and on the metallic collector 4 of the metal structure 3 in the direction of the metal structure 3 on the other. This presses the coating 2 against or into the upper side of the metal structure 3, creating an upper section 6 of the metal structure 3 against or into which the coating 2 is pressed. Furthermore, the metallic collector 4 is pressed into the lower side of the metal structure 3, so that a lower section 7 of the metal structure 3 is formed, into which the metallic collector 4 is pressed.

### EXAMPLE—PRODUCTION OF A NEGATIVE ELECTRODE FOR A GALVANIC CELL

On an aluminum foil as a metal structure (foil thickness: 10 μm), a coating of aluminum silicate is first applied to the first side (upper side) by doctoring, so that a coating of aluminum silicate with a wet film thickness of 300 μm is created on the upper side of the aluminum foil.

A stainless steel wire mesh (made of 1.4301 stainless steel with a mesh width of 0.04 mm, a wire diameter of 0.028 mm and a thickness of 10 μm) is applied to a second side of the coated aluminum foil (lower side) as a metallic collector.

The aluminum silicate coating is then pressed onto or into the upper side of the aluminum foil using a cold lever press at a pressing pressure of 3500 kg/cm² at room temperature (25° C.) for 15 seconds and the stainless steel wire mesh is pressed into the lower side of the aluminum foil. The result is an aluminum foil with the aluminum silicate coating pressed onto or into the upper side and the stainless steel wire mesh pressed into the lower side, with the stainless steel wire mesh in this case being pressed into the lower side of the aluminum foil over its entire height.

### List of Reference Signs

1: upper press ram of a cold lever press;
2: coating on the upper side of the metal structure (e.g., aluminum silicate coating);
3: metal structure (e.g., aluminum foil);
4: metallic collector (e.g., stainless steel wire mesh);
5: lower press ram of a cold lever press;
6: upper section of the metal structure onto or into which the coating is pressed; and
7: lower section of the metal structure into which the metallic collector is pressed.

1-16. (canceled)

17. A method for producing a negative electrode for a galvanic cell, comprising the steps of
(a) providing a planar metal structure selected from the group consisting of metal foil, expanded metal, perforated metal, metal mesh and combinations thereof, wherein the planar metal structure has a planar upper side and a planar lower side and has a certain height in a direction perpendicular to the upper side and lower side, wherein the metal structure is not made of lithium metal;
(b) applying a coating to the upper side of the metal structure, the coating comprising a polymer and/or ceramic particles;
(c) applying a planar upper side of a planar metallic collector to the lower side of the metal structure, wherein the metallic collector has a planar lower side and has a certain height in a direction perpendicular to the upper side and lower side which is at most as great as the height of the metal structure, wherein the metallic collector has a plurality of openings at least on the upper side; and
(d) pressing the metallic collector over a certain distance, which corresponds at least partially to the height of the metallic collector, into the metal structure by exerting mechanical pressure on the lower side of the metallic collector, whereby the openings of the metallic collector fill with metal of the metal structure at least along the certain distance.

18. The method according to claim 17, wherein the metal structure
(i) comprises aluminum, wherein the aluminum is optionally alloyed with a metal other than aluminum, and/or
(ii) comprises at least one element selected from the second main group of the periodic table, the third main group of the periodic table, the fourth main group of the periodic table, or a subgroup of the periodic table, and/or
(iii) has a height, in a direction perpendicular to a surface of the metal structure, in the range from 1 to 100 μm, and/or
(iv) has an upper side and/or lower side which has a surface texturing.

19. The method according to claim 18, wherein the aluminum or the optionally alloyed aluminum is present in a proportion of 0.1 to 20.0% by weight with respect to the total weight of the metal structure;

20. The method according to claim 17, wherein the surface texturing is selected from the group consisting of brushed surface texturing, ribbed surface texturing, embossed surface texturing, and combinations thereof.

21. The method according to claim 18, wherein the at least one element is selected from the group consisting of magnesium, indium, zinc, tin, silicon, and manganese.

22. The method according to claim 17, wherein the ceramic particles of the coating
(i) comprise a material selected from the group consisting of ceramic oxide, ceramic sulfide, ceramic sulfate, ceramic phosphide, ceramic phosphate, ceramic silicate, ceramic nitride, ceramic nitrate, and combinations thereof, or
(ii) have an average particle diameter d 50 in the range from 0.05 to 30 μm, the average particle diameter referring to a particle diameter determined by dynamic light scattering.

23. The method according to claim 17, wherein the material is selected from the group consisting of lithium phosphorus sulfide, lithium germanium phosphorus sulfide, lithium silicon phosphorus sulfide, Li₆PS₅Cl, Li₆PS₅Br, alumina, aluminosilicate, lithium aluminosilicate and combinations thereof.

24. The method according to claim 17, wherein the polymer of the coating
(i) comprises a plastic selected from the group consisting of acrylonitrile-butadiene rubber, hydrogenated acrylonitrile-butadiene rubber, polyisobutylene, and combinations thereof; and/or
(ii) comprises a fluorinated plastic selected from the group consisting of PVDF, PVDF-HFP, and combinations thereof.

25. The method according to claim 17, wherein the coating
(i) is mechanically rolled on; and/or
(ii) is applied via wet coating and/or dry coating; and/or
(iii) is pressed onto or into the metal structure by exerting a mechanical pressure on the coating in the direction of the metal structure of at least 2000 kg/cm²; and/or
(iv) in a direction perpendicular to the upper side of the metal structure, has a height in the range of 0.05 to 200 μm, and/or
(v) is a porous coating; and/or
(vi) is contacted with a liquid electrolyte and/or gel electrolyte for a galvanic cell, which comprises a liquid selected from the group consisting of EC, PC, DMC, EMC, DEC, VEC, VC, FEC, TBAC (acetyltributyl citrate), GTB (glycerol tributyrate), GTA (glycerol triacetate), y-butyrolactone, ionic liquid, and combinations thereof; and/or comprises a lithium conducting salt and/or a sodium conducting salt, wherein the lithium conducting salt is selected from the group consisting of LiPF₆, LiClO₄, LiNO₃, C₆H₁₈LiNSi₂, F₂LiNO₄S₂, C₂F₆LiNO₄S₂, LiB[C₂O₄]₂, LiBF₄ and combinations thereof and/or the sodium conducting salt selected from the group consisting of NaPF₆, NaBF₄, NaTF, NaTFSI, NaClO₄ and combinations thereof; and/or
(vii) assumes a quasi-solid state or a gel-like state through contact with a liquid electrolyte.

26. The method according to claim 17, wherein the metallic collector
(i) comprises a metal that has a higher Vickers hardness than the metal of the metal structure; and/or
(ii) comprises a metal selected from the group consisting of stainless steel, copper, nickel and combinations and alloys thereof, and/or
(iii) is pressed into the metal structure by applying a mechanical pressure of at least 2000 kg/cm² to the underside of the metallic collector in the direction of the metal structure, and/or
(iv) has a plurality of continuous openings from the upper side to the lower side; and/or
(v) contributes to mechanical resistance to volumetric expansion during cycling when the electrode is operated in a galvanic cell; and/or
(vi) in a direction perpendicular to the lower side of the metal structure, has a height in the range from 1 to 100 μm.

27. The method according to claim 17, wherein the metallic collector is designed as a perforated foil or a perforated expanded metal or wire mesh.

28. The method according to claim 17, wherein the metallic collector is designed as a wire mesh, wherein the wire mesh
(i) has a mesh size in the range from 0.01 to 0.1 mm; and/or
(ii) comprises wires which have a diameter in the range from 0.020 to 0.050 mm.

29. A negative electrode for a galvanic cell, comprising
(i) a planar metal structure selected from the group consisting of metal foil, expanded metal, perforated metal, metal mesh and combinations thereof, wherein the metal structure has a planar upper side and a planar lower side and has a certain height in a direction perpendicular to the upper side and lower side, wherein the metal structure is not made of lithium metal;
(ii) a coating applied to the upper side of the metal structure, the coating comprising a polymer and/or ceramic particles; and
(iii) a planar metallic collector, wherein the metallic collector has a planar upper side and planar lower side and has a certain height in a direction perpendicular to the upper side and lower side which is at most as great as the height of the metal structure, wherein the metallic collector has a plurality of openings at least on the upper side;
wherein the metallic collector is embedded in the metal structure over a certain distance from the lower side of the metal structure towards the upper side of the metal structure, wherein the certain distance corresponds at least partially to the height of the metallic collector and wherein openings of the metallic collector are filled with metal of the metal structure at least along the certain distance.

30. The electrode according to claim 29, wherein the metal structure
(i) comprises aluminum, wherein the aluminum is optionally alloyed with a metal other than aluminum; and/or
(ii) comprises at least one element selected from the second main group of the periodic table, the third main group of the periodic table, the fourth main group of the periodic table, a subgroup of the periodic table and combinations thereof; and/or
(iii) has a height, in a direction perpendicular to an upper side of the metal structure, in the range from 1 to 100 μm; and/or
(iv) has an upper side and/or lower side which has a surface texturing.

31. The electrode according to claim 29, wherein the ceramic particles of the coating comprise a material selected from the group consisting of ceramic oxide, ceramic sulfide, ceramic sulfate, ceramic phosphide, ceramic phosphate, ceramic silicate, ceramic nitride, ceramic nitrate, and combinations thereof, and/or have an average particle diameter d50 in the range from 0.05 to 30 μm, the average particle diameter referring to a particle diameter determined by dynamic light scattering.

32. The electrode according to claim 31, wherein the material is selected from the group consisting of lithium phosphorus sulfide, lithium germanium phosphorus sulfide, lithium silicon phosphorus sulfide, Li₆PS₅Cl, Li₆PS₅Br, alumina, aluminosilicate, lithium aluminosilicate, and combinations thereof.

33. The electrode according to claim 29, wherein the polymer of the coating
(i) comprises a plastic selected from the group consisting of acrylonitrile-butadiene rubber, hydrogenated acrylonitrile-butadiene rubber, polyisobutylene and combinations thereof; and/or
(ii) comprises a fluorinated plastic selected in particular from the group consisting of PVDF, PVDF-HFP, and combinations thereof.

34. The electrode according to claim 29, wherein the coating
(i) is mechanically rolled on; and/or
(ii) is applied via wet coating and/or dry coating; and/or
(iii) was pressed onto or into the metal structure by exerting a mechanical pressure on the coating in the direction of the metal structure of at least 2000 kg/cm²; and/or
(iv) in a direction perpendicular to the upper side of the metal structure, has a height in the range of 0.05 to 2 μm; and/or
(v) is a porous coating; and/or
(vi) has a liquid electrolyte and/or gel electrolyte for a galvanic cell, which electrolyte comprises a liquid selected from the group consisting of EC, PC, DMC, EMC, DEC, VEC, VC, FEC, TBAC (acetyltributyl citrate), GTB (glycerol tributyrate), GTA (glycerol triacetate), y-butyrolactone, ionic liquid, and combinations thereof, and/or
(vii) comprises a lithium conducting salt selected from the group consisting of LiPF₆, LiClO₄, LiNO₃, C₆H₁₈LiNSi₂, F₂LiNO₄S₂, C₂F₆LiNO₄S₂, LiB[C₂O₄]₂, LiBF₄, and combinations thereof and/or the sodium conducting salt is selected from the group consisting of NaPF₆, NaBF₄, NaTF, NaTFSI, NaClO₄, and combinations thereof; and/or
(viii) has a liquid electrolyte that is present in a quasi-solid state or a gel-like state.

35. The electrode according to claim 29, wherein the metallic collector
(i) comprises a metal that has a higher Vickers hardness than the metal of the metal structure; and/or
(ii) comprises a metal selected from the group consisting of stainless steel, copper, nickel and combinations and alloys thereof, and/or
(iii) was pressed into the metal structure by applying a mechanical pressure of at least 2000 kg/cm²; and/or
(iv) has a plurality of continuous openings from the upper side to the lower side; and/or
(v) contributes to mechanical resistance to volumetric expansion during cycling when the electrode is operated in a galvanic cell; and/or
(v) has a height in the range from 1 to 100 μm in a direction perpendicular to the lower side of the metal structure.

36. The electrode according to claim 29, wherein the metallic collector is designed as a perforated foil, perforated expanded metal, or wire mesh.

37. The electrode according to claim 36, wherein the metallic collector is designed as a wire mesh, the wire mesh (i) having a mesh size in the range from 0.01 to 0.1 mm, in particular in the range from 0.04 to 0.063 μm; and/or (ii) comprises or consists of wires which have a diameter in the range from 0.020 to 0.050 mm.

38. A galvanic cell comprising a negative electrode according to claim 29, a cathode, and an electrolyte.

39. A method of providing power supply to a mobile device, a vehicle, an aircraft, a ship; and/or a stationary device comprising utilizing a galvanic cell according to claim 38.
